(19) United States
(12) Patent Application Publication
(10) Pub. No.: US 2013/0346870 A1
(43) Pub. Date: Dec. 26, 2013

(54) MULTI-USER TARGETED CONTENT DELIVERY

(71) Applicants: Michael Froimowitz Greenzeiger, Santa Clara, CA (US); Steven C. Bredenberg, Campbell, CA (US)

(72) Inventors: Michael Froimowitz Greenzeiger, Santa Clara, CA (US); Steven C. Bredenberg, Campbell, CA (US)

(73) Assignee: Apple Inc., Cupertino, CA (US)

(21) Appl. No.: 13/531,412

(22) Filed: Jun. 22, 2012

(51) Int. Cl. G06F 3/01; G06F 15/16

(52) U.S. Cl. 715/733

(57) ABSTRACT

The present technology delivers a multi-user targeted content package to a group of users. The multi-user targeted content package can include single-user and multi-user interactive content. A multi-user targeted content package can be delivered in bursts so that multiple users receive the content package during the same time period. In some cases, users can be grouped into instances of the multi-user targeted content package based on factors such as location, language, demographics, bandwidth, skill level, and/or other similarity measures. Additionally, some multi-user content can require a minimum number of users before the content becomes fully active, such as a multi-player game.

### BACKGROUND

1. Technical Field

The present disclosure relates to targeted content delivery and, more specifically, to increasing a user's exposure to targeted content through multi-user targeted content.

2. Introduction

For many organizations, product success is directly linked to product and brand awareness. To increase awareness, organizations commonly present invitational content regarding the product or brand, such as an advertisement, to a user. Initially, invitational content could be presented through channels in which the content provider had a virtually captive audience. For example, a television viewer had the option of watching an advertisement or changing the channel. However, due to technological advancements users are often able to consume desired content while having little or no contact with invitational content. For example, users are able to fast forward through advertisements while watching television programs through the use of DVR technology, or in many cases users can even obtain the same television programs without advertisements via the Internet for free or for a minimal fee.

To increase a user's willingness to receiving or engage with invitational content many content providers rely on targeted content delivery. That is, instead of creating a single message and delivering it to every member of the general public, a content provider can identify a segment of the population that is likely to have the greatest interest in their message and deliver the message to only those individuals. For example, a user may be more willing to receive invitational content, such as an advertisement while viewing a television program, if the user believes the content will be of interest. A key aspect of targeted content delivery is identifying those individuals whose characteristics satisfy the target demographics for a particular item of targeted content. Otherwise, even if the user agrees to receive the targeted content, the user is unlikely to engage with the content.

Regardless of the sophistication of the targeted content delivery system, a user's exposure to and engagement with invitational content can remain low. This often occurs when the user's engagement with the primary content, such as an application or web page, is brief. For example, a user may use a social media application frequently throughout the day, however, the duration of each individual use may be rather short thus limiting the user's exposure to and interaction with targeted content. Therefore, in many cases, targeted content delivery alone is an insufficient means of increasing exposure and awareness.

### SUMMARY

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

Disclosed are systems, methods, and non-transitory computer-readable storage media for increasing a user's exposure to targeted content through multi-user targeted content. A method comprises rendering a multi-user targeted content package on a first client device. The multi-user content package can include single-user and/or multi-user invitational content. In some cases, the multi-user content package can be configured so that the single-user content is enabled. That is, when the multi-user content package is rendered on the first client device the single-user content is active and the multi-user content is inactive. At some point after rendering the multi-user content package, the first client device can receive an enable notification. The enable notification can instruct the client device to enable the multi-user content. That is, make the multi-user content active. The enable notification can be received when a predefined minimum number of client devices have received the multi-user content package. The enable notification can also be received in response to a first user activating the multi-user content, such as by clicking on a banner advertisement. In some cases, when the client device enables the multi-user content, the single-user content can be automatically disabled.

After the multi-user content has been enabled, the first user can interact with the multi-user content. Data representing the first user's interaction can be sent to each client device currently rendering the multi-user targeted content package. In some cases, the interaction data can be sent directly to each of the other client devices. Furthermore, the interaction data can also be sent to a server, such as a content delivery system or a multi-user content system. By also sending the interaction data to a server, a record of various achievements or other interaction events can be maintained. Alternatively, the interaction data can be sent to a server and then distributed to the other client devices.

The first client device can also receive interaction data, the received data can represent a second user's interaction with the multi-user targeted content package rendered on a second client device. For example, the received data can represent a move in a game or a chat message. After receiving the interaction data, the first client device can render the data. The rendering can enable the first user to perceive the second user's interaction with the multi-user content.

In some embodiments, the multi-user content package can also include locked content. The first client device can receive an unlock notification once a predefined event has occurred. The predefined event can include completion of a multi-user targeted content package session, engagement with a predefined number of multi-user content packages, and/or a predefined achievement. In some cases, the record constructed from the interaction data can be used to determine the occurrence of a predefined event.

A second method comprises receiving at a content delivery system multiple requests for a targeted content package. The requests can be received from multiple client devices and each client device can be associated with a user. The content delivery system can select a group of client devices from the multiple client devices requesting content. In some embodiments, the content delivery system can select the group of client devices based on a common assignment to an identified segment. In some embodiments, the content delivery system can select the group based on an attribute common to the client devices. The attribute can include a location, network bandwidth, operating system, and/or device type. In some embodiments, the content delivery system can select the group based on a prioritized ranking of the client devices and/or users. The prioritization can be based on a number of factors including location, length of time since request, network bandwidth, user characteristics, skill level, and/or previous interaction history.

After selecting the group of client devices, the content delivery system can select a multi-user targeted content package for the group. In some cases, the selection can be based on attributes and/or characteristics of the group. The content delivery system can then send the selected multi-user content package to each client device in the group. In some cases, the sending can be delayed so that it occurs in bursts. This enables multiple users to receive the multi-user content package during the same time period. The delay can be for a predefined period of time and/or until the selected group of client devices reaches a predefined minimum number of client devices.

### BRIEF DESCRIPTION OF THE DRAWINGS

In order to describe the manner in which the above-recited and other advantages and features of the disclosure can be obtained, a more particular description of the principles briefly described above will be rendered by reference to specific embodiments thereof which are illustrated in the appended drawings. Understanding that these drawings depict only exemplary embodiments of the disclosure and are not therefore to be considered to be limiting of its scope, the principles herein are described and explained with additional specificity and detail through the use of the accompanying drawings in which:

FIG. 1 illustrates an exemplary configuration of devices and a network;

FIG. 2 illustrates a first exemplary content package containing multi-user content;

FIG. 3 illustrates a second exemplary content package containing multi-user content;

FIG. 4 illustrates a third exemplary content package containing multi-user content;

FIG. 5 illustrates an exemplary content package with a chat feature;

FIG. 6 illustrates exemplary invitational indicating a number of users participating in the multi-user invitational content;

FIG. 7 illustrates an exemplary method embodiment for distributing a multi-user targeted content package to a group of client devices;

FIG. 8 illustrates an exemplary method embodiment for serving a multi-user content package;

FIG. 9 illustrates an exemplary method embodiment for distributing an instance of a multi-user content package to a subset of requesting users;

FIG. 10 illustrates an exemplary method embodiment for updating an instance of a multi-user content package;

FIG. 11 illustrates an exemplary method embodiment for distributing a multi-user content package in which the multi-user content is disabled;

FIG. 12 illustrates an exemplary method embodiment for rendering a multi-user content package; and

FIG. 13 illustrates an exemplary system embodiment.

### DETAILED DESCRIPTION

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure.

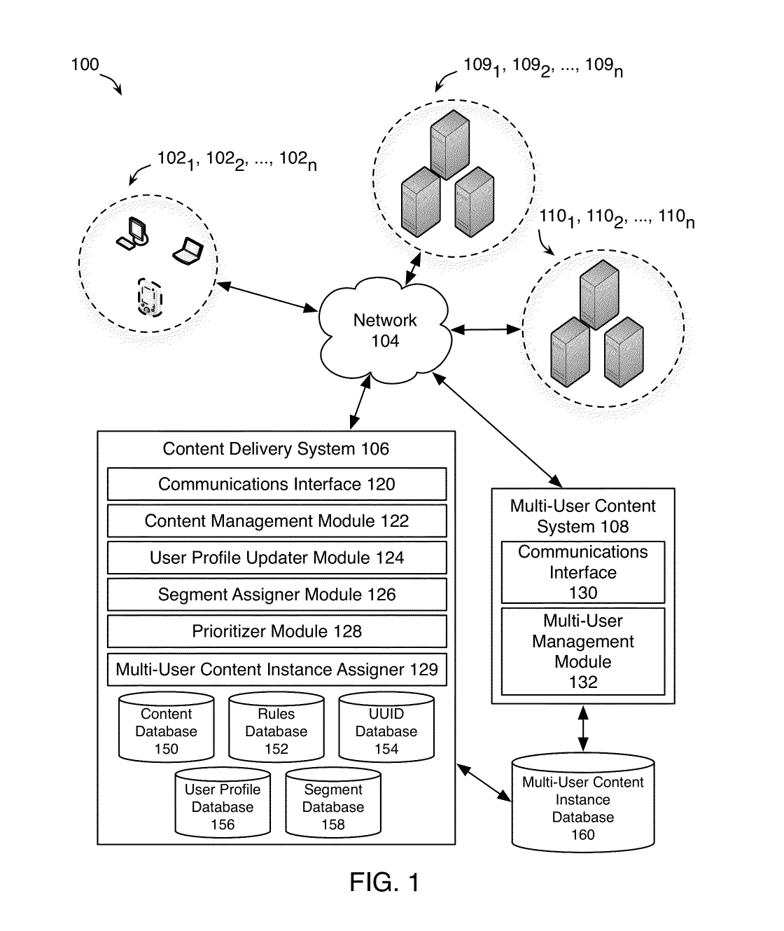

The present disclosure addresses the need in the art to increase user exposure to and the duration of the engagement with targeted content. Using the present technology it is possible to increase user interest in targeted content through the delivery of multi-user targeted content packages. An exemplary system configuration 100 is illustrated in FIG. 1, wherein electronic devices communicate via a network for purposes of exchanging content and other data. The system can be configured for use on a local area network such as that illustrated in FIG. 1. However, the present principles are applicable to a wide variety of network configurations that facilitate the intercommunication of electronic devices. For example, each of the components of system 100 in FIG. 1 can be implemented in a localized or distributed fashion in a network.

In system 100, invitational content can be delivered to user terminals 102₁, 102₂, . . . , 102ₙ (collectively “102”) connected to a network 104 by direct and/or indirect communications with a content delivery system 106. User terminals 102 can be any network enabled client devices capable of receiving a content package and displaying a user interface, such as desktop computers; mobile computers; handheld communications devices, e.g. mobile phones, smart phones, tablets; smart televisions; set-top boxes; and/or any other network enabled computing devices. Furthermore, content delivery system 106 can concurrently accept connections from and interact with multiple user terminals 102.

The content delivery system 106 can receive a request for electronic content, such as a web page, an application, a media item, etc., from one of user terminals 102. Thereafter, the content delivery system 106 can assemble a content package and transmit the assembled content page to the requesting one of user terminals 102. To facilitate communications with the user terminals 102 and/or any other device or component, the content delivery system 106 can include a communications interface 120.

The content delivery system 106 can include a content management module 122 to facilitate the generation of an assembled content package. Specifically, the content management module 122 can combine content from one or more primary content providers 109₁, 109₂, . . . , 109ₙ (collectively “109”) and content from one or more secondary content providers 110₁, 110₂, . . . 110ₙ (collectively “110”) to generate the assembled content package for the user terminals 102. For example, in the case of a web page being delivered to a requesting one of user terminals 102, the content management module 122 can assemble a content package by requesting the data for the web page from one of the primary content providers 109 maintaining the web page. For the invitational content on the web page provided by the secondary content providers 110, the content management module 122 can request the appropriate data according to the arrangement between the primary and secondary content providers 109 and 110. Additionally, the content management module 122 can create content packages that contain content from a single content provider. That is, a content package can contain only primary content or a content package can contain only secondary content. However, the content package is not limited to the content from content providers 109 and 110. Rather, the content package can include other data generated at the content delivery system 106. In some embodiments, the content delivery system 106 can preselect the content package before a request is received.

An assembled content package can include text, graphics, audio, video, executable code, or any combination thereof. Further, an assembled content package can include invitational content designed to inform or elicit a pre-defined response from the user. In some embodiments, the invitational content can be associated with a product or can directly or indirectly advertise a product. For example, the assembled content package can include one or more types of advertisements from one or more advertisers.

Additionally, the invitational content can be active invitational content. That is, invitational content that is designed to primarily elicit a pre-defined response from a user. For example, active invitational content can include one or more types of advertisements configured to be clicked upon, solicit information, or be converted by the user into a further action, such as a purchase or a download of the advertised item. However, invitational content can also be passive invitational content. That is invitational content that is designed to primarily inform the user, such as a video. In some cases, passive invitational content can include information that can lead or direct users to other invitational content including active invitational content.

Furthermore, the invitational content can be dynamic invitational content. That is invitational content that varies over time or that varies based on user interaction. For example, dynamic invitational content can include an interactive game. However, the various embodiments are not limited in this regard and the invitational content can include static invitational content that neither varies over time nor with user interaction. In the various embodiments, invitational content in a content package can be static or dynamic and active or passive. A content package can include a combination of various types of invitational content in a single content package.

In some cases, a content package can replace or update invitational content in a content package already delivered to a user terminal. For example, a first content package can include an app that can be installed on the user terminal 102. A subsequent content package can include one or more items of invitational content that can be presented to a user of the user terminal 102 while the user interacts with the app.

Although primary and secondary providers 109 and 110 are presented herein as separate entities, this is for illustrative purposes only. In some cases, the primary and the secondary content providers 109 and 110 can be the same entity. Thus, a single entity can provide both the primary and the secondary content.

The content management module 122 can be configured to request that content be sent directly from content providers 109 and 110. Alternatively, a cached arrangement can also be used to improve performance of the content delivery system 106 and improve overall user experience. That is, the content delivery system 106 can include a content database 150 for locally storing/caching content maintained by content providers 109 and 110. The data in the content database 150 can be refreshed or updated on a regular basis to ensure that the content in the database 150 is up to date at the time of a request from a user terminal 102. However, in some cases, the content management module 122 can be configured to retrieve content directly from content providers 109 and 110 if the metadata associated with the data in the content database 150 appears to be outdated or corrupted.

An assembled content package can also include single-user and/or multi-user interactive content. In the case of single-user interactive content, multiple users may receive the same content, but each user can only perceive their own actions with respect to the content. On the other hand, with multi-user interactive content multiple users can simultaneously interact with the same content and each user can perceive the actions of the other users. For example, an item of multi-user interactive content can be a multi-player game, such as a real time game, a head-to-head game, or a turn-based game. In another example, the multi-user interactive content can include a chat feature where a user can chat with other users and/or a customer representative. In some cases, the interactive content can itself be invitational content. Alternatively, the interactive content can be content provided by a primary content provider 109 and the invitational content can be embedded in the interactive content. For example, the interactive content can be a multi-player poker game and the back of the cards can incorporate invitational content, such as product logo. However, in some configurations, a multi-player game containing invitational content can itself be invitational content. That is, multi-user interactive content can be multi-user invitational content. Likewise, single-user interactive content can be single-user invitational content. Additionally, different content providers can provide the single-user and multi-user interactive content in an assembled content package.

A user interacting with a content package can be a user of a user terminal 102. Additionally, a user can be a computer-based user, e.g. a simulated user controlled by artificial intelligence. For example, in a multi-player game one or more players can be artificial players controlled by a computer, such as the content delivery system 106 or the multi-user interactive content system 108.

In some cases, an assembled content package can include both single-user and multi-user interactive content. Furthermore, the content package can be assembled such that only one type of interactive content is active. For example, a content package can be distributed to a user with the multi-user content initially disabled. At some later point, the multi-user interactive content can be activated. For example, the activation can occur in response to an action by the user or by the occurrence of some other event, such as a predefined number of users receiving the multi-user content or the user achieving a predefined goal.

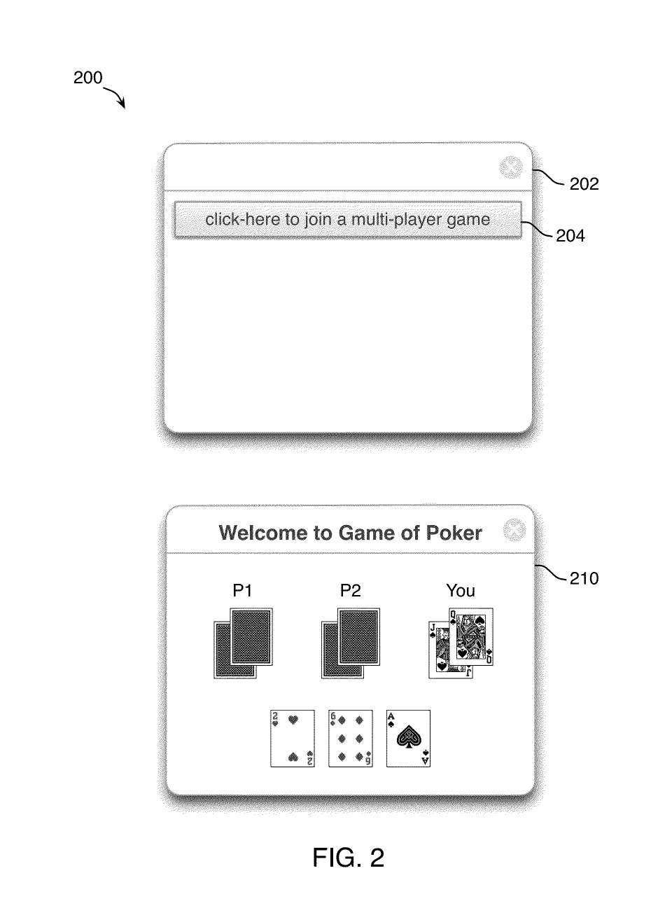

FIG. 2 illustrates a first exemplary content package 200 containing both single-user and multi-user content where the multi-user invitational content is initially disabled. Upon receiving the content package 200, the user terminal 102 can display the single-user content 202, which contains a banner advertisement 204. To activate the multi-user invitational content 210, the user must click on the banner advertisement 204. In this example, the multi-user invitational content 210 is a multi-player poker game. The display on the user terminal 102 switches from the single-user content 202 to the multi-player game room 210 when the user clicks on the banner advertisement 204. As illustrated in FIG. 2, in some cases, activation of the multi-user content can cause the single-user content to be disabled. That is, an effect of the user clicking on the banner advertisement can be the activation of a multi-user interactive environment, such as entering the multi-player game room 210. In the exemplary content package 200, by activating the multi-user content, the user has left the single-user content 202 thereby disabling it. In some cases, the single-user content can be re-enabled, such as by exiting a multi-player game.

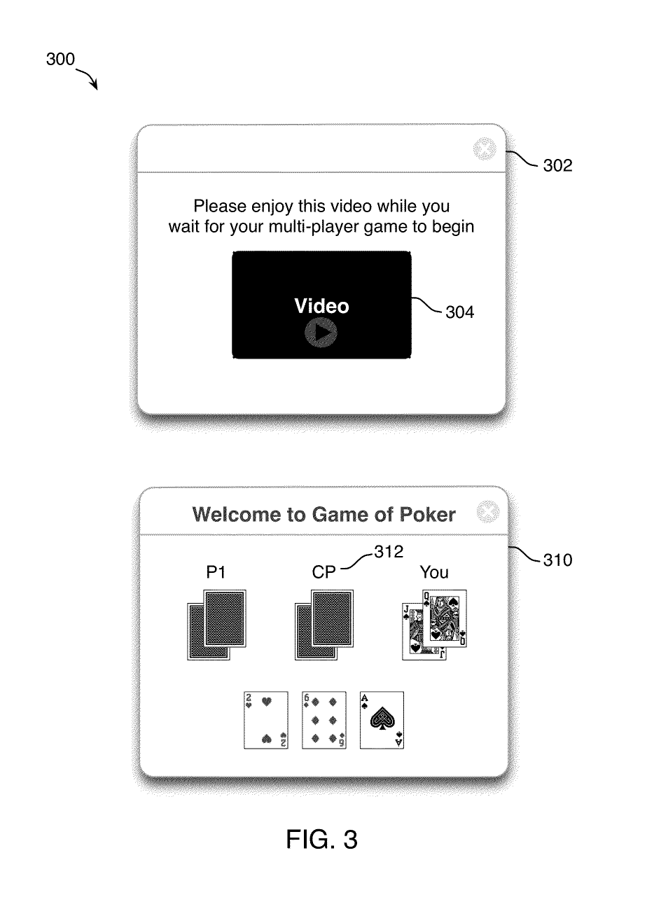

FIG. 3 illustrates a second exemplary content package 300 containing both single-user and multi-user content where the multi-user invitational content is initially disabled. Upon receiving the content package 300, the user terminal 102 can display the single-user content 302 that contains invitational content 304. In some cases, multi-user invitational content can require that a minimum number of users have received the multi-user content before the multi-user content is activated for any user. This can occur, for example, when the multi-user content is a multi-player game. For multi-user content that requires a minimum number of users, such as multi-user content 310, the multi-user content can be automatically enabled once the requisite number of users is achieved. During the delay, the user terminal can display an item of single-user content, such as video 304. In some cases, if the delay has reached a predefined threshold amount of time, such as the length of video 304, without reaching the requisite number of users, the multi-user content can be activated with one or more computer-based players. In some cases, the multi-user invitational content can reveal that one or more of the players is computer-based, such as player 312.

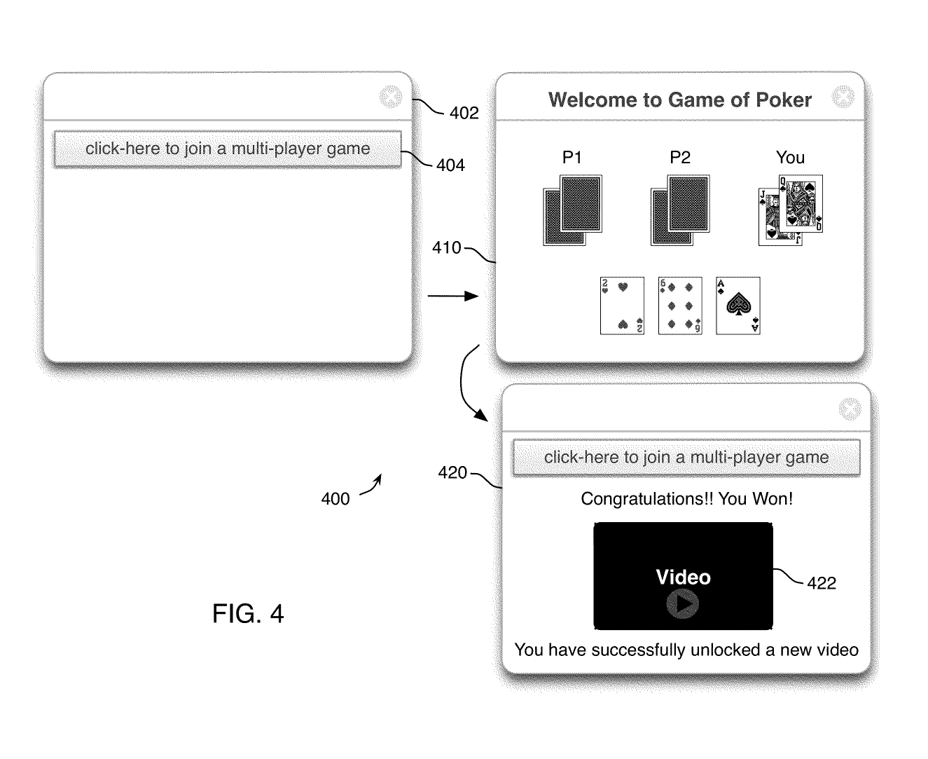

A content package can also be distributed with some single-user content disabled. At some later point, the single-user content can be activated, such as in response to the occurrence of a predefined event, e.g. user achieving a predefined goal. FIG. 4 illustrates an exemplary content package 400 containing both single-user and multi-user content where an item of single-user invitational content is disabled. Upon receiving the content package 400, the user terminal 102 can display the single-user content 402, which contains a banner advertisement 404. To activate the multi-user invitational content 410, the user can click on the banner advertisement 404. In response to the click, the user terminal 102 can display the multi-user invitational content 410, which is a multi-user poker game. Upon completing the game, the user terminal 102 can return to displaying the single-user content 420. In this case, based on the user's performance in the multi-user invitational content 410, new single-user invitational content 422 has been unlocked. In some cases, a user's interaction with multi-user invitational content can unlock additional multi-user invitational content as well, such as additional levels, new multi-player games, new multi-player features, etc.

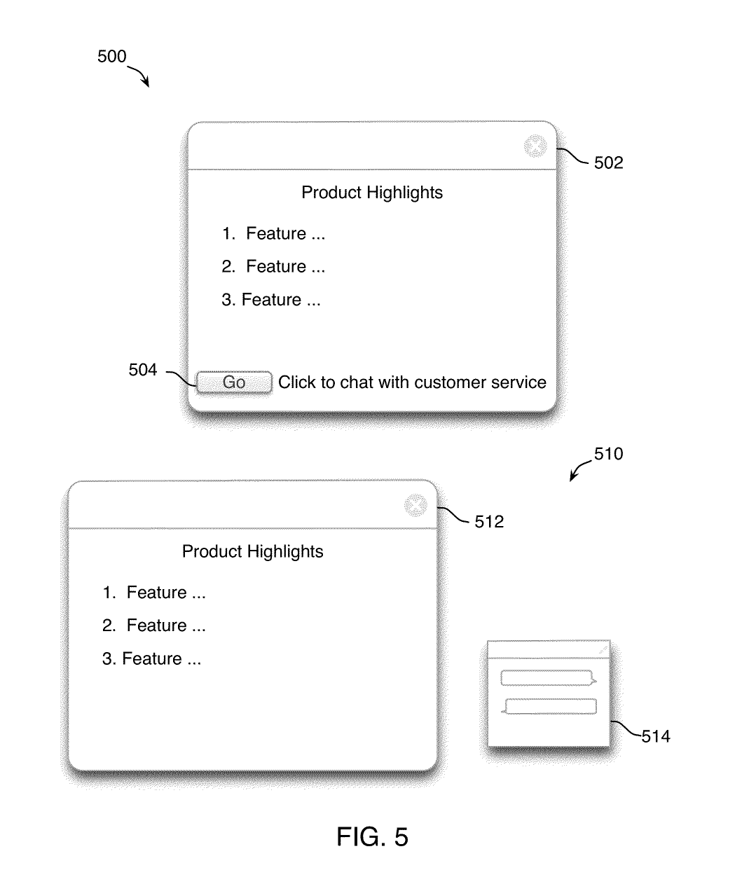

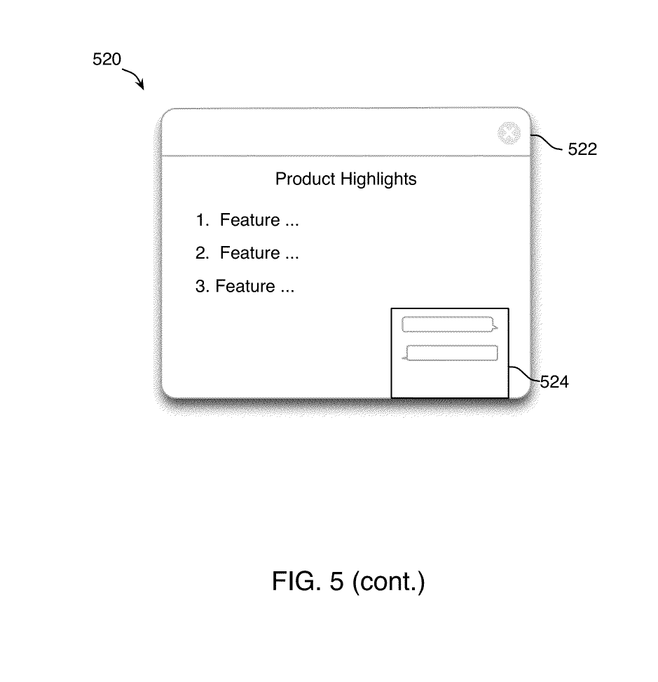

In some content packages, single-user content can remain active after multi-user content has been activated. FIG. 5 illustrates a content package 500 that includes single-user invitational content 502 with a chat feature. The chat feature can be used to enable a user to speak with a customer service representative associated with the invitational content 502. To activate the multi-user chat content, the user can click the button 504. The chat feature can be activated in a new window, such as in the scenario illustrated as 510. In the scenario illustrated as 510, the single-user invitational content is still active in window 512 and the chat feature has been activated in window 514. Alternatively, the chat feature can be activated in a designated portion of the current display, such as in the scenario illustrated as 520. In the scenario illustrated as 520, the single-user invitational content is still active in window 522 and the chat feature has been activated at position 524, i.e. the lower left corner. In both scenarios 510 and 520, the user can continue to interact with the single-user content after the multi-user content has been enabled. In some cases, a customer service representative may not be available to chat at the time that a user clicks the chat button. When this occurs, the content can be configured to default to some other content, such as a click to call feature or some other single-user content.

The chat feature can also be used in conjunction with multi-user invitational content. For example, a chat feature can be included in a multi-player game. In this case, the chat feature can be used to enable a user to chat with other players in the game and/or a customer service representative. In some cases, a chat window can be visible only to the user participating in the chat. For example, if the game has four players and players 1 and 2 are using the chat feature to talk, the chat window and its contents will only be visible to players 1 and 2, and not players 3 and 4. Likewise, if a player is chatting with a customer service representative, the chat window and its contents will only be visible to the player and the customer service representative. Such a feature can be useful in multi-user invitational content where users are encouraged to play games or complete tasks as teams. However, in some cases, the chat window can be visible to all players.

In some embodiments, a chat feature can include a moderator. The moderator can be used to review the contents of a message before the message is distributed to other users. Depending on the configuration, the moderating can be manual, e.g. reviewed by a human; and/or automated, e.g. based on keyword filtering. In some cases, the review can be a combination of automated and manual review. For example, the filtering software can flag chat messages for review by a human. A moderator may be desirable in some multi-user invitational content to protect minors, prevent attacks against other users, prevent cheating in a game, etc.

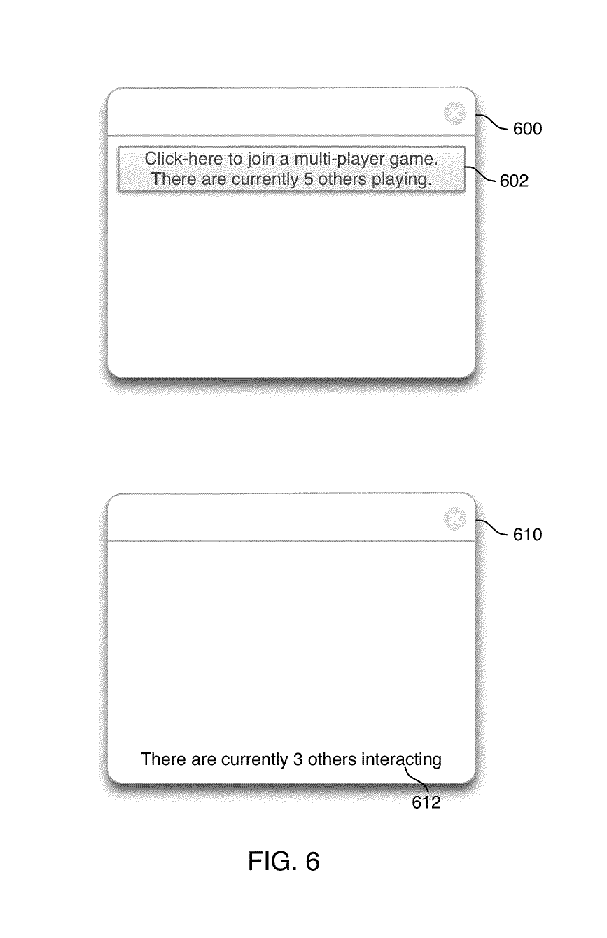

Furthermore, a content package can be assembled such that the content displayed to the user can include an indication of the number of users currently interacting with the multi-user content. For example, FIG. 6 illustrates two items of invitational content 600 and 610 that include an indication of the number of users participating in the multi-user invitational content. The invitational content item 600 includes a banner advertisement 602 that can be used to activate multi-user invitational content. The banner advertisement 602 can include an indication of the number of users currently engaged with the multi-player game. Such an indication can be used to encourage a user to activate the multi-user content. That is, a user may be more likely to click on the banner advertisement if the user knows other users are currently playing the game or interacting with the multi-user content.

The invitational content item 610 is a multi-user interactive environment, such as a multi-player game. In this case, the multi-user content 610 includes an indication 612 of the number of other users currently engaged with the content. Such an indication can be used to encourage users to continue interacting with the multi-user content. For example, in the case of a multi-player game, such as an adventure game, the user may not encounter another player right away or for a period of time. This could lead the user to think that no other users are playing the game and thus the user may lose interest and quit the game. However, if the user is made aware that other players are indeed playing, the user may continue.

Even though FIGS. 2-5 illustrate initially displaying the content package with single-user content enabled, a content package can be assembled such that it only contains multi-user content or it is initially displayed with multi-user content enabled. For example, a content package can be assembled such that upon receiving the content package, the user terminal 102 displays a multi-player game.

Referring back to FIG. 1, the system 100 can also be configured to include a multi-user content system 108. The multi-user content system 100 can manage the event sending between the various user terminals 102. In some cases, the a user terminal 102 can send event data to the multi-user content system 108 and the multi-user content system 108 can distribute the data to the other user terminals 102. The data can represent a user's interaction with a multi-user content item, such as multi-user invitational content. However, the system 100 can also be configured so that the user terminals 102 can send event data directly to the other user terminals 102 participating in the multi-user game. For example, the user terminal 102 can send the event data via multi-casting. By sending the data directly to the other participating user terminals 102 time lag can be minimized. A user terminal 102 can also send the event data to the multi-user content system 108, such as for monitoring.

The multi-user content system 108 can include a communications interface 130 that can send and receive data. The communications interface 130 can pass the data to the multi-user management module 132. The multi-user management module 132 can process the data to identify the user event. Possible user events can include activating, exiting, interacting, achieving a predefined event, etc. In some cases, the multi-user management module 132 can simply pass the data along to the other user terminals 102 on which the multi-user content is active. For example, if the data represents a move in a game, the multi-user management module 132 can pass that move along so that the other users perceive the move. However, in some cases, the multi-user management module 132 can receive data relevant to the management of an instance of a multi-user content item, such as an activation or exit event.

The system 100 can include a multi-user content instance database 160 that can store information regarding each active instance of a multi-user content item. In particular, the multi-user content instance database 160 can store an entry for each active instance. An entry can include a content item identifier, an instance identifier, the number of engaged users, and user terminal identifiers. In some cases, more or less information can be stored in each entry. The multi-user management module 132 can update the multi-user content instance database 160 to reflect the received data. For example, upon receiving an activation event, the multi-user management module 132 can update an instance entry to reflect the new user, e.g. increment the number of engaged users and add the new user terminal identifier. In some cases, the multi-user management module 132 can, in addition to updating the multi-user content instance database 160, send an update to the other user terminals 102, such as to update the display indicating the number of active users. Furthermore, in some cases, the multi-user management module 132 can send data to the content delivery system 106. For example, an event can be the occurrence of a predefined event, such as completing a conversion, interacting with the content for a predefined amount of time, completing the content, winning the game, etc. When such information is stored in a user profile, the multi-user management module 132 can be configured to communicate the information to the content delivery system 106 for storage in a user profile, such as in the user profile database 156.

Although the content delivery system 106 and the multi-user content system 108 are presented here as separate entities, this is for illustrative purposes only. In some cases, the content delivery system 106 can include the multi-user content system 108. Thus a single entity can both deliver a content package containing multi-user invitational content and manage the event sending between the user terminals 102.

As described above, content maintained by the content providers 109 and 110 can be combined according to a predefined arrangement between the two content providers, which can be embodied as a set of rules. In an arrangement where the content delivery system 106 assembles the content package from multiple content providers, the assembly rules can be stored in a rules database 152 in the content delivery system 106. The content management module 122 can be configured to assemble the content package for user terminals 102 based on these rules. The rules can specify how to select content from secondary content providers 110 and primary content providers 109 in response to a request from one of user terminals 102. For example, in the case of a web page maintained by one of primary content providers 109 and including invitational content, the rules database 152 can specify rules for selecting one of the secondary providers 110. The rules can also specify how to select specific content from the selected one of secondary providers 110 to be combined with the content provided by one of primary providers 109. For example, if the invitational content is to be selected from one of several multi-player games, the rule can specify a turn-based game when the user terminal 102 is connected over a network with a bandwidth below a specified threshold, such as 3G. In some cases, an item of primary content, such as an app or other media object, can have one or more associated attributes. For example, an app can have one or more associated genre attributes, e.g. travel, sports, education, etc. A rule can be based at least in part on the primary content attributes. Once assembled, the assembled content package can be sent to a requesting one of user terminals 102.

Additionally, rules for combining primary and secondary content can be based on user characteristics known about the user. In particular, in some cases, interactive content can be selected based on the characteristics of the requesting user(s). As used herein, the term “user characteristics” refers to the characteristics of a particular user associated with one or more of user terminals 102. User characteristics can include channel characteristics, demographic characteristics, behavioral characteristics, and spatial-temporal characteristics. Channel characteristics can define the specific delivery channel being used to deliver a content package to a user. For example, channel characteristics can include a type of electronic content, a type of device or user terminal, a carrier or network provider, or any other characteristic that defines a specific delivery channel for the content package. Spatial-temporal characteristics can define a location, a location zone, a date, a time, or any other characteristic that defines a geographic location and/or a time for delivery of the content package. Demographic characteristics can define characteristics of the users targeted by the content or associated with the content. For example, demographic characteristics can include age, income, ethnicity, gender, occupation, or any other user characteristics. Behavioral characteristics can define user behaviors for one or more different types of content, separately or in combination with any other user characteristics. That is, different behavioral characteristics may be associated with different channel, demographic, or spatial-temporal characteristics. User characteristics can also include characteristics descriptive of a user's state of mind including characteristics indicative of how likely a user is to click on or convert an item of invitational content if it were displayed to the user. User characteristics can be learned directly or derived indirectly from a variety of sources. In some embodiments, the user characteristic values can be collected from one or more databases. For example, if the user is registered with an online media service, such as the ITUNES store maintained by Apple Inc. of Cupertino, Calif., the collected data could include the user's registration information. Such data can provide values for declared user characteristics. Furthermore, the content delivery system 106 can be configured to learn of or derive user characteristics from any number of other information sources. For example, in some configurations, the content delivery system 106 can derive or infer one or more user characteristic values from user characteristic values already known about the user.

In some embodiments, the interactive content can be associated with one or more targeted segments. A targeted segment can be viewed as defining a space or region in k-dimensional space, where each of the k dimensions is associated with one of a plurality of user characteristics. In the various embodiments, the k dimensions can include both orthogonal and non-orthogonal dimensions. That is, some of the k dimensions can overlap or can be related in some aspect.

In the various embodiments, the content delivery system 106 can also include a unique user identifier (UUID) database 154 that can be used for managing sessions with the various user terminal devices 102. The UUID database 154 can be used with a variety of session management techniques. For example, the content delivery system 106 can implement an HTTP cookie or any other conventional session management method (e.g., IP address tracking, URL query strings, hidden form fields, window name tracking, authentication methods, and local shared objects) for user terminals 102 connected to content delivery system 106 via a substantially persistent network session. However, other methods can be used as well. For example, in the case of handheld communications devices, e.g. mobile phones, smart phones, tablets, or other types of user terminals connecting using multiple or non-persistent network sessions, multiple requests for content from such devices may be assigned to a same entry in the UUID database 154. The content delivery system 106 can analyze the attributes of requesting devices to determine whether such requests can be attributed to the same device. Such attributes can include device or group-specific attributes.

In some embodiments, the content delivery system 106 can include a user-profile database 156. The user-profile database 156 can, at least in part, be constructed based on declared user characteristics related to one or more users. In some cases, the user-profile database may contain inferred or derived user characteristic values. The user-profile database 156 can be updated using a user-profile-updater module 124. In some embodiments, the user-profile-updater module 124 can be configured to add additional profile data, update profile data, fill in missing profile data, or infer user characteristic values from declared data.

In addition to the user characteristics previously described, the user profile database 156 can include information related to a user's interaction with the received interactive content. For example, a user's profile can include a history of the number and type of interactive content received, e.g. single-user, multi-user, real time game, turn-based game, chat, etc. Furthermore, the history can include the user's level of interaction with the interactive content, e.g. failed to activate multi-user content, exited multi-user content early, participated for predefined threshold period of time, completed, won game, defeated n number of players, etc. In some embodiments, the user's interactive content history can be used in selecting interactive content for the user, for unlocking additional content, and/or for rewarding the user. For example, a user's interactive content history can be used to award badges, publish rankings of top users, and/or to motivate users in other ways to continue interacting with multi-user content. In another example, a user's interactive content history can be used to de-prioritize or blacklist a user from receiving future multi-user interactive content. In some cases, information in a user's interactive content history can be received from the multi-user content system 108.

The user-profile-updater module 124 can also be configured to maintain the user profile database 156 to include only more recently acquired data or to re-derive any inferred characteristics in order to ensure that the user profile is an accurate reflection of the current state of the user (location, state of mind, behaviors, demographics, etc. can change rapidly). For example, the user-profile-updater module 124 can be configured to maintain the user profile database 156 to include only data from the last two to three months. However, the user-profile-updater module 124 can be configured to adjust the data in the user profile database 156 to cover any span of time. In some instances the user-profile-updater module 124 can update the profile database 156 in real-time. Alternatively, the user-profile-updater module 124 can be configured to set an expiration period on a subset of the data in the user profile database 156. For example, a policy can specify that user declared data is maintained as long as the user account is active, but user characteristic values based on location information expire after a specified period of time. In some cases, a user can set the expiration period. In some instances, the user-profile-updater module 124 can update the user profile database 156 at least every week, or every day. In some cases, the content delivery system 106 can receive a direct request to update one or more user profiles. The update request can come directly from the user's device or any other device capable of communicating with the content delivery system 106, such as other content delivery networks or websites. In some cases, the content delivery system 106 can receive an indirect request to update one or more user profiles. An indirect request can be the result of receiving new user characteristic values. An update request can occur at any time.

In some embodiments, the content delivery system 106 can include a segment database 158 that is used to aid in selecting invitational content to target to users. The segment database 158 can store defined segments and associations between the segments and users and/or invitational content that should be targeted to users associated with the segments. As described above, a targeted segment can be defined based on one or more user characteristics or derivatives thereof and can be associated with one or more items of invitational content. Additionally, a targeted segment can be associated with one or more users. In some embodiments, by associating a targeted segment with both a user and an item of invitational content, the delivery system can match invitational content with users. In some embodiments, the content delivery system 106 can update the segment database 158 to add newly defined targeted segments or to delete targeted segments.

In some cases a targeted segment can be as simple as a single user characteristic identifier and a single user characteristic value. For example, the common demographic identifiers of gender, age, occupation, or income can each be used in defining corresponding targeted segments. A characteristic value can also be assigned to the identifier. For example, the values of male, 19, and student can be assigned to the user characteristics of gender, age, and occupation, respectively. However, more complex targeted segments can also be defined that consist of one or more identifiers with one or more values associated with each identifier. For example, a targeted segment can be defined to target a user with the following characteristics: gender, male; age, 19-24; location, Northern California or New York City. Additional exemplary segments are described throughout this disclosure. Furthermore, targeted segments can correspond to one or more segments that content providers are likely to easily understand and thus can quickly identify as being relevant to their content. Additionally, in some embodiments, content providers 109 and 110 can define a custom targeted segment.

In some embodiments, the content delivery system 106 can provide a segment assigner module 126. The segment assigner module 126 can apply a set of user characteristics associated with a user (including segments to which a user has been previously assigned) to assign the user to one or more targeted segments. The assigner module 126 can obtain the set of user characteristic values from the user profile database 154 and/or from the user's activities during the current session. The segment assigner module 126 can assign a user to one or more defined targeted segments in the segment database 158, or alternatively, a user can be assigned to a custom targeted segment defined to meet specific goals of a content provider.

Based on the assigned segments, the user profile database 156 can be updated to reflect the segment assignments. Additionally, the content delivery system 106 can use the segment assignments to select targeted content. In some cases, the user profile data in the user profile database 156 can change over time so the segment assigner module 126 can be configured to periodically update the segment assignments in the user profile database 156. The segment assignment update can be triggered at specified intervals, upon detection of a change in the user profile database 156, and/or upon detection of a specified activity in the content delivery system 106.

In some embodiments, the content delivery system 106 can provide a prioritizer module 128. The prioritizer module 128 can perform a variety of prioritizing tasks based on the configuration of the content delivery system 106. In some configurations, the prioritizer module 128 can prioritize the targeted segments assigned to a user. The prioritization can be influenced by a number of factors, which can include the user's context, a content provider's campaign goals, and/or the content that is currently available for display to the user. A request to prioritize the targeted segments can be explicit or implicit and can be made by any component of the system 100. For example, a secondary content provider 110 can explicitly request that the content delivery system 106 prioritize the targeted segments or the request can be implicit as part of a request for a content package. The resulting prioritized list can be provided, for example, to the content management module 122, which can then use the information to assemble and deliver a content package. Additionally, the prioritized list can be stored, for example in the user profile, for later use.

In some embodiments, the prioritizer module 128 can prioritize the multi-user invitational content assigned to a user. The prioritization can be based on a number of factors. The content delivery system 106 can be configured to maintain a number of currently engaged users for each item or instance of multi-user content. The prioritizer module 128 can use the number of engaged users to prioritize the multi-user content. For example, the prioritizer module 128 can assign a lower ranking to an item of multi-user content when the associated number of active users is above a predefined threshold value. Such a prioritization scheme can be used with multi-user content where the user experience will degrade after a specified number of active users. In another example, the prioritizer module 128 can assign a higher ranking to an item of multi-user content when the associated number of active users is within a predefined range. Such as prioritization scheme can be used with multi-user content where the user experience is enhanced by having a certain number of active users. The prioritization can be based on additional factors as well, such as the user's profile; characteristics or attributes of the user terminal associated with the user, e.g. network bandwidth, operating system, device type, etc.; and user location; etc.

In some embodiments, the prioritizer module 128 can prioritize the user assigned to an instance of multi-user content. The users can be prioritized based on a number factors including a user's location, length of time since request for a content package, network bandwidth, user characteristics, skill level, etc. For example, a user can be assigned a higher ranking than another user if the user's wait-time, i.e. time since request, has exceeded a predefined threshold value, or the user has just been waiting longer. The higher ranking can occur even if the other user is a better match for the multi-user content. In another example, a user can be assigned a lower ranking for a run-time game if the user's network bandwidth is below a specified bandwidth. Additionally, a user's ranking can be based at least in part on the user's interaction history with multi-user content. For example, a user can be assigned a lower ranking when the user's interaction history includes a predefined number of early exits from multi-user content. In another example, a user can receive a higher ranking when the user's interaction history includes a predefined number of completions of multi-user content. In some cases, a completion can be defined based on length of time the user spent interacting with the multi-user content. A completion can also be defined based on achieving a predefined goal, such as downloading content, completing a conversion, winning a game, completing a series of actions, etc. In yet another example, a user can receive a higher ranking based on the user's skill level, which can be determined based on past performance.

The content delivery system 106 can also include a multi-user content instance assigner 129. In some cases, it can be desirable to limit the number of users that are simultaneously interacting with an item of multi-user content. For example, a multi-user game may have a maximum number of players. In another example, it may be desirable to limit the number of users within a chat to avoid overwhelming the engaged users with too many messages. To facilitate this feature, the multi-user instance assigner 129 can create one or more instances of an item of multi-user content. In this case, an instance of a multi-user content item can be defined by the group of users who are interacting with the same multi-user environment. For example, a multi-user content item can have a maximum number of engaged users set to three. If the content delivery system 106 receives five requests for a targeted content package, the multi-user content instance assigner 129 can create two instances of the multi-user content item. The multi-user content instance assigner 129 can assign three users to the first instance and two users to the second instance.

The multi-user content instance assigner 129 can assign users to an instance as a request is received and/or in bursts. For example, the multi-user content instance assigner 129 can delay assigning users to an instance until a minimum number of requests have been received. After receiving the minimum number of requests, the multi-user content instance assigner 129 can group the users and assign them as a group to an instance.

In some cases, the multi-user content instance assigner 129 can randomly assign the users to a particular instance. However, it can be advantageous to group users based on one or more factors, such as location, language, demographics, network bandwidth, user preferences, user interests, game skill level, etc. The groupings can be created to generate a multi-user environment in which the users are more likely to remain engaged. For example, users assigned to an instance based on location are all likely to have the same latency and may even have similar interests. In another example, users assigned based on user characteristic values are likely to have similar interests and/or behaviors and thus they are likely to interact well in a multi-user environment. In yet another example, users assigned based on network bandwidth are not likely to experience a poor user experience resulting from changes in performance due to network speeds. In a further example, users assigned based on skill level are not likely to get frustrated with the varied skill levels of the players and exit early. In some embodiments, the multi-user content instance assigner 129 can assign users based on rankings assigned by the prioritizer module 128. For example, the prioritizer module 128 can rank the users assigned to a multi-user content item. The multi-user content instance assigner 129 can then assign users by selecting the top n ranked users.

As previously described, an item of multi-user invitational content can be distributed in a disabled state and can then be activated by the user, such as by clicking a button or banner advertisement. When the multi-user invitational content is activated, the multi-user content instance assigner 129 can receive a notification, such as from the multi-user content system 108. In response to the notification, the multi-user content instance assigner 129 can assign the user to an instance. In some cases, the instance will already exist and the multi-user content instance assigner 129 can identify an instance from the multi-user instance database 160. Alternatively, the multi-user content instance assigner 129 can create a new instance to which to assign the user. In either case, the multi-user content instance assigner 129 can update the multi-user content instance database 160 to reflect the new assignment.

As described above, one aspect of the present technology is the gathering and use of data available from various sources to improve the delivery to users of invitational content or any other content that may be of interest to them. The present disclosure contemplates that in some instances, this gathered data may include personal information data that uniquely identifies or can be used to contact or locate a specific person. Such personal information data can include demographic data, location-based data, telephone numbers, email addresses, twitter ID's, home addresses, or any other identifying information.

The present disclosure recognizes that the use of such personal information data, in the present technology, can be used to the benefit of users. For example, the personal information data can be used to deliver targeted content that is of greater interest to the user. Accordingly, use of such personal information data enables calculated control of the delivered content. Further, other uses for personal information data that benefit the user are also contemplated by the present disclosure.

The present disclosure further contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. For example, personal information from users should be collected for legitimate and reasonable uses of the entity and not shared or sold outside of those legitimate uses. Further, such collection should occur only after receiving the informed consent of the users. Additionally, such entities would take any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of advertisement delivery services, the present technology can be configured to allow users to select to “opt in” or “opt out” of participation in the collection of personal information data during registration for services. In another example, users can select not to provide location information for targeted content delivery services. In yet another example, users can select to not provide precise location information, but permit the transfer of location zone information.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, content can be selected and delivered to users by inferring preferences based on non-personal information data or a bare minimum amount of personal information, such as the content being requested by the device associated with a user, other non-personal information available to the content delivery services, or publically available information.

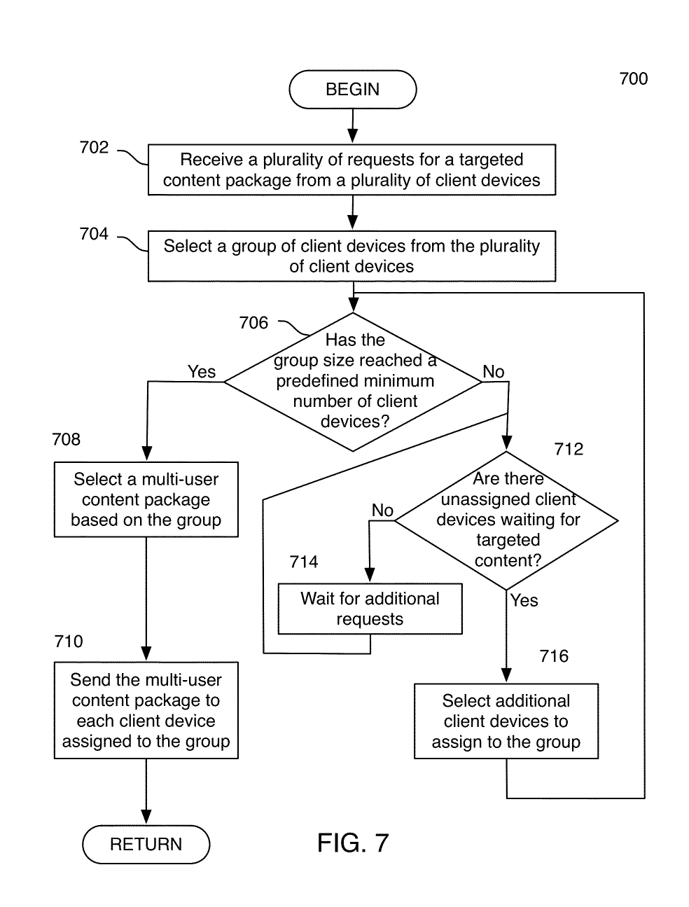

FIG. 7 is a flowchart illustrating steps in an exemplary method 700 for distributing multi-user targeted content packages. For the sake of clarity, this method is discussed in terms of an exemplary system such as is shown in FIG. 1. Although specific steps are shown in FIG. 7, in other embodiments a method can have more or less steps than shown.

The content delivery system 106 can receive multiple requests for a targeted content package from multiple client devices, such as user terminals 102 (702). Each client device can be associated with a user. In some cases, a request can include a variety of information, such as a unique user identifier, user characteristic data, client device attributes, etc. After receiving the requests, the content delivery system 106 can select a subset of the client devices (704). The manner in which the subset of client devices is selected can vary with the configuration of the system. In some embodiments, the content delivery system 106 can assign the users to one or more segments. After assigning the users to the segments, the content delivery system 106 can identify at least one segment. For example, the content delivery system 106 can identify a segment based on requirements specified by one or more content providers. The content delivery system 106 can form the subset from the users assigned to the at least one identified segment. In some embodiments, the content delivery system 106 can select the subset of client devices based on the attributes of the client devices requesting a targeted content package. For example, the content delivery system 106 can select client devices based on the location of the client devices, the client devices' network bandwidth, the operating system running on the client devices, and/or the type of the client device. In some embodiments, the content delivery system 106 can select the subset of client devices based on the user profiles of the users associated with the client devices requesting a targeted content package. For example, the selection can be made based on demographics, achievement level, skill level, previous response to multi-user invitational content, etc. Additional techniques for selecting a subset of client devices are also possible, such as random selection.

Once the content delivery system 106 selects a subset of client devices, the content delivery system 106 checks if the number of client devices in the subset has reached a predefined minimum number of client devices (706). In some cases, the minimum number may not matter or can be low, such as two client devices. If the minimum number has not been reached, the content delivery system 106 can delay sending a multi-user content package to the subset of client devices until the predefined number has been reached. During the delay, the content delivery system 106 can check if client devices are waiting for targeted content that have yet to be assigned (712). If so, the content delivery system 106 can identify additional client devices that meet the requirements of the subset and assign them to the subset (716). After assigning new client devices to the subset, the content delivery system 106 can check if the predefined size has been reached (706). However, if no unassigned client devices are waiting, the content delivery can wait for additional requests for targeted content packages (714).

In some cases, the content delivery system 106 can have a maximum delay so that client devices that have requested content do not have to wait too long. In response to reaching the maximum delay, the content delivery system can be configured to proceed with the currently selected group of client devices or adjust the requirements for adding a client device to the subset. For example, the content delivery system 106 can select an additional segment, client device attribute, and/or user profile value.

Once the minimum number has been reached, the content delivery system 106 can select a multi-user content package based on the set of client devices (708). For example, if the subset was selected based on at least one segment, the content delivery system 106 can select the multi-user content package based on the at least one segment. Additionally, the content delivery system 106 can select the multi-user content package based on the demographics of the users, attributes of the client devices, location, etc. After selecting a multi-user content package, the content delivery system 106 can send the multi-user content package to each client device in the selected subset of client devices (710). After sending the multi-user content package, the content delivery system 106 can resume previous processing, which can include repeating method 700.

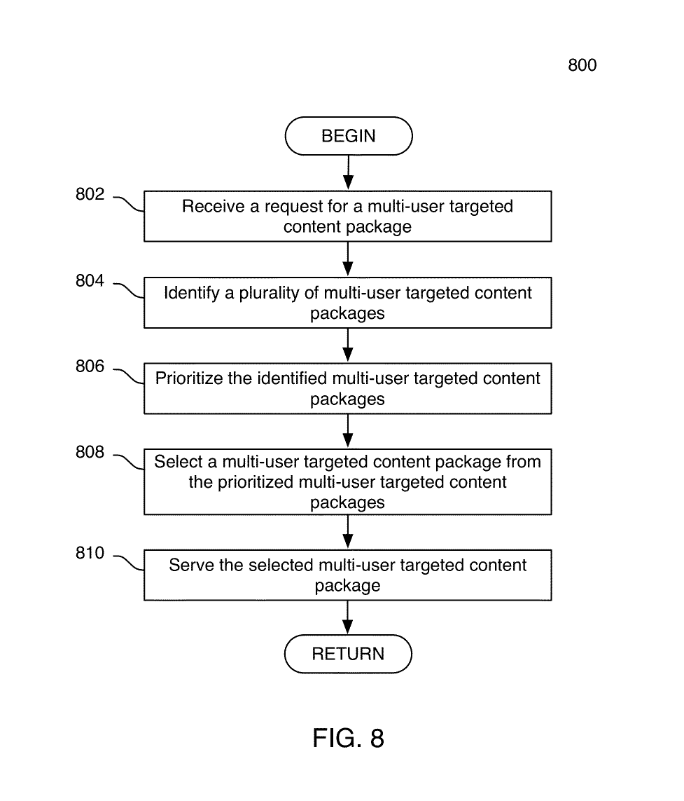

FIG. 8 is a flowchart illustrating steps in an exemplary method 800 for serving a multi-user targeted content package. For the sake of clarity, this method is discussed in terms of an exemplary system such as is shown in FIG. 1. Although specific steps are shown in FIG. 8, in other embodiments a method can have more or less steps than shown.

The content delivery system 106 can receive a request for a multi-user targeted content package (802). In some cases, the multi-user targeted content package can include single-user content and multi-user content. The request can be received from a client device, such as a user terminal 102. The client device can be associated with a user. In some cases, the request can include a variety of information, such as a unique user identifier, user characteristic data, client device attributes, etc. After receiving the request, the content delivery system 106 can identify one or more multi-user targeted content packages for the requesting user (804). The manner in which the one or more multi-user content packages are identified can vary with the configuration of the system. For example, the multi-user targeted content packages can be identified based on the user's profile, attributes of the client device, one or more segments to which the user is assigned, the user's location, etc. In some cases, each multi-user targeted content package can have an associated number of engaged users. That is, the number of users currently interacting with the multi-user targeted content package. In some cases, the number is specific to an instance of the multi-user targeted content package.

After identified one or more multi-user targeted content packages, the content delivery system 106 can prioritized the identified multi-user content packages (806). The prioritization can be based on a variety of factors. For example, the content delivery system 106 can rank a multi-user content package lower when the associated number of currently engaged users is above a predefined threshold value. In another example, the content delivery system 106 can rank a multi-user content package higher when the associated number of currently engaged users is within a predefined range. Additional prioritization techniques are also possible. Once the multi-user content packages are prioritized, the content delivery system 106 can select a multi-user content package from the prioritized multi-user content packages (808) and serve it to the requesting client device (810). After serving the multi-user content package, the content delivery system 106 can resume previous processing, which can include repeating method 800.

In some embodiments, after serving the multi-user content package, the content delivery system 106 can receive a notification, from a client device that had previously received the multi-user targeted content package, of a change in engagement with the multi-user targeted content package. In some cases, the change in engagement can be an activation of the multi-user content, such as when the multi-user content package is delivered with the multi-user content disabled. For example, a multi-user content package can include a banner advertisement and the user activates the multi-user content by clicking on the banner advertisement. Alternatively, the change in engagement can be an exit from the multi-user content. For example, when a user completes or quits a multi-user game. After receiving a notification of a change in engagement, the content delivery system 106 can update the associated number of engaged users for the multi-user targeted content package.

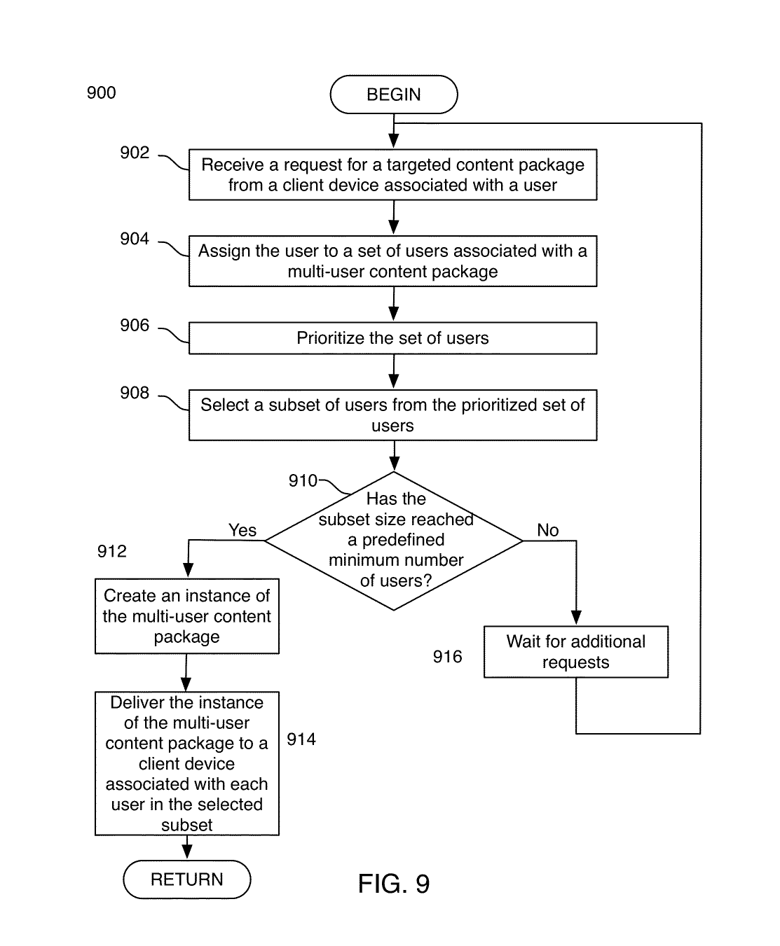

FIG. 9 is a flowchart illustrating steps in an exemplary method 900 for distributing an instance of a multi-user targeted content package to a subset of requesting users. For the sake of clarity, this method is discussed in terms of an exemplary system such as is shown in FIG. 1. Although specific steps are shown in FIG. 9, in other embodiments a method can have more or less steps than shown.

The content delivery system 106 can receive a request for a multi-user targeted content package (902). The request can be received from a client device, such as a user terminal 102. The client device can be associated with a user. In some cases, the request can include a variety of information, such as a unique user identifier, user characteristic data, client device attributes, etc. After receiving the request, the content delivery system 106 can assign the user to a set of users associated with a multi-user content package (904). The content delivery system 106 can assign the user to a set of users based on a number of factors, which can include one or more values in the user's profile, the network bandwidth of the user's client device, the user's location, and/or the user's skill level.

After assigning the user, the content delivery system 106 can prioritize the set of users (906). The content delivery system 106 can use a variety of factors to prioritize the set of users. In some cases, the content delivery system 106 can prioritize the set of users based on at least one of the user locations, the length of time since request, user characteristics, and/or client device characteristics. Additionally, the content delivery system 106 can prioritize the set of users by ranking each user based on the user's interaction history with the multi-user content and/or all multi-user content received by the user. For example, the content delivery system 106 can rank a user lower if the user's interaction history includes a predefined number of early exits from a multi-user targeted content package. In another example, the content delivery system 106 can rank a user higher if the user's interaction history includes a predefined number of completions of a multi-user targeted content package.

Once the set of users are prioritized, the content delivery system 106 can select a subset of the users (908) and check if the number of users in the subset has reached a predefined minimum number of users (910). In some cases, the minimum number may not matter or can be low, such as two users. If the minimum number has not been reached, the content delivery system 106 can delay sending a multi-user content package to the subset of users until the predefined number has been reached. During the delay, the content delivery system 106 can wait for additional requests (916) and process the requests (902) to assign the users to a set.

In some cases, the content delivery system 106 can have a maximum delay so that users that have requested content do not have to wait too long. In response to reaching the maximum delay, the content delivery system 106 can be configured to proceed with the currently selected group of users or adjust the requirements for adding a user to the subset. For example, the content delivery system 106 can change the prioritization method or select an additional segment, client device attribute, and/or user profile value.

Once the minimum number has been reached, the content delivery system 106 can create an instance of the multi-user content package (912). After creating the instance of the multi-user content package, the content delivery system 106 can send the instance a client device associated with each user in the selected subset of users (914). After delivering the instance of the multi-user content package, the content delivery system 106 can resume previous processing, which can include repeating method 900.

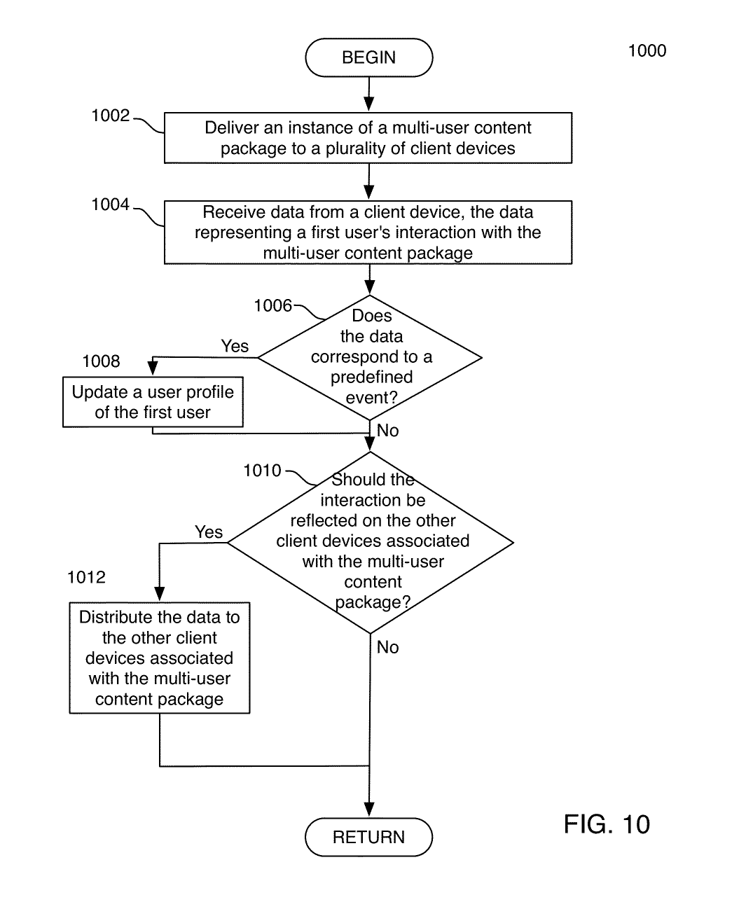

FIG. 10 is a flowchart illustrating steps in an exemplary method 1000 for updating an instance of a multi-user content package. For the sake of clarity, this method is discussed in terms of an exemplary system such as is shown in FIG. 1. Although specific steps are shown in FIG. 10, in other embodiments a method can have more or less steps than shown.

The content delivery system 106 can delivery an instance of a multi-user content package to multiple client devices (1002). At some later time, the content delivery system 106 can receive data from a client device (1004). The data can represent a first user's interaction with the multi-user content package. Upon receiving the data, the content delivery system 106 can check if the data corresponds to a predefined event (1006). For example, the predefined event can be the completion of the multi-user content, winning a game, interacting with the multi-user content for a predetermined period of time, and/or exiting the multi-user content. In response to determining that the user has satisfied a predefined event, the content delivery system 106 can update the user profile of the first user (1008). Furthermore, in some cases, the content delivery system 106 can deliver an additional content package to the user. For example, in response to the user completing the multi-user content or winning a game, the content delivery system 106 can deliver a content package that unlocks content in the multi-user targeted content package. In another example, in response to detecting that the user has achieved the predefined event, the content delivery system 106 can deliver a content package that enhances the multi-user targeted content package.

Once the content delivery system 106 has made any necessary updates to the first user's profile, the content delivery system 106 can check if the first user's interaction should be reflected on the other client devices associated with the multi-user content package (1010). If so, the content delivery system 106 can distribute the data to the other client devices (1012). After the content delivery system 106 distributes any necessary data, the content delivery system 106 can resume previous processing, which can include repeating method 1000.

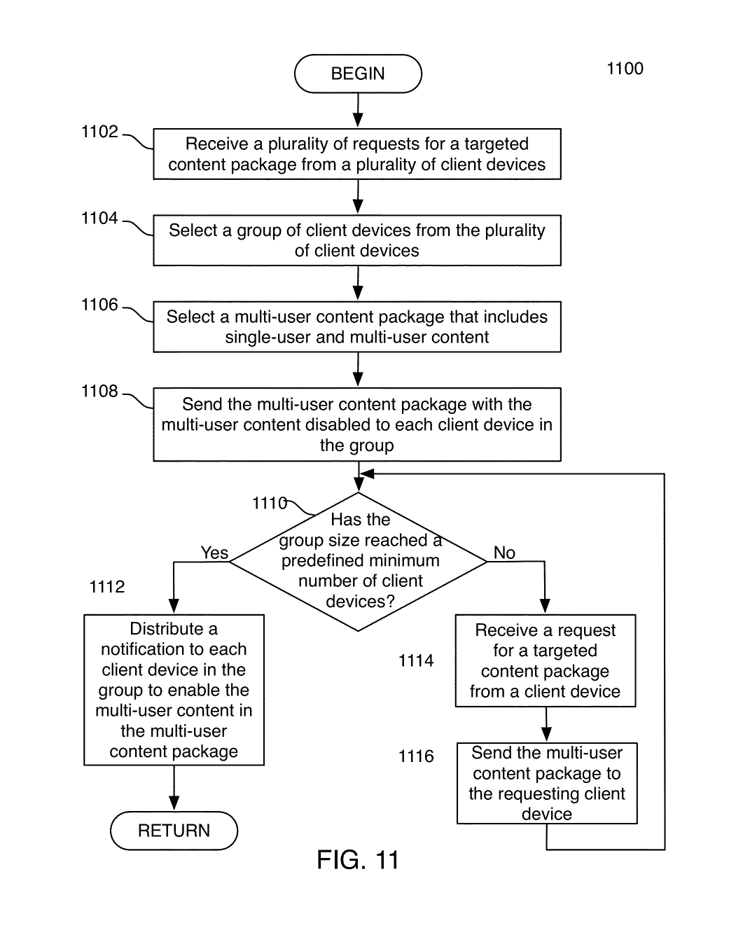

FIG. 11 is a flowchart illustrating steps in an exemplary method 1100 for distributing multi-user targeted content packages in which the multi-user content is disabled. For the sake of clarity, this method is discussed in terms of an exemplary system such as is shown in FIG. 1. Although specific steps are shown in FIG. 11, in other embodiments a method can have more or less steps than shown.

The content delivery system 106 can receive multiple requests for a targeted content package from multiple client devices, such as user terminals 102 (1102). Each client device can be associated with a user. In some cases, a request can include a variety of information, such as a unique user identifier, user characteristic data, client device attributes, etc. After receiving the requests, the content delivery system 106 can select a subset of the client devices (1104). The manner in which the subset of client devices is selected can vary with the configuration of the system.

After selecting a subset of client devices, the content delivery system 106 can select a multi-user content package that includes single-user and multi-user content (1106). For example, the multi-user content package can include a multi-player game and/or a chat feature. Once selected, the content delivery system 106 can send the multi-user content package to each client device in the selected subset of client devices (1108). The multi-user content package can be configured such that when the multi-user content package is displayed on the client device at least an item of multi-user invitational content is disabled. That is, the single user content is enabled, while at least some of the multi-user content is disabled.

After sending the multi-user content package, the content delivery system 106 can check if the size of subset of client devices that have received the multi-user content package has reached a predefined minimum number of client devices (1110). If the subset size has not reached the predefined minimum, the content delivery system 106 can receive an additional request for a targeted content package from an additional client device (1114) and send the multi-user content package to the requesting client device (1116). After sending out the additional multi-user content package, the content delivery system can again check if the predefined size has been reached (1110). Once the size has been reached, the content delivery system 106 can distribute a notification to each client device that has received the multi-user content package to enable the multi-user content in the multi-user content package (1112). After the content delivery system 106 distributes the enable notification, the content delivery system 106 can resume previous processing, which can include repeating method 1100.

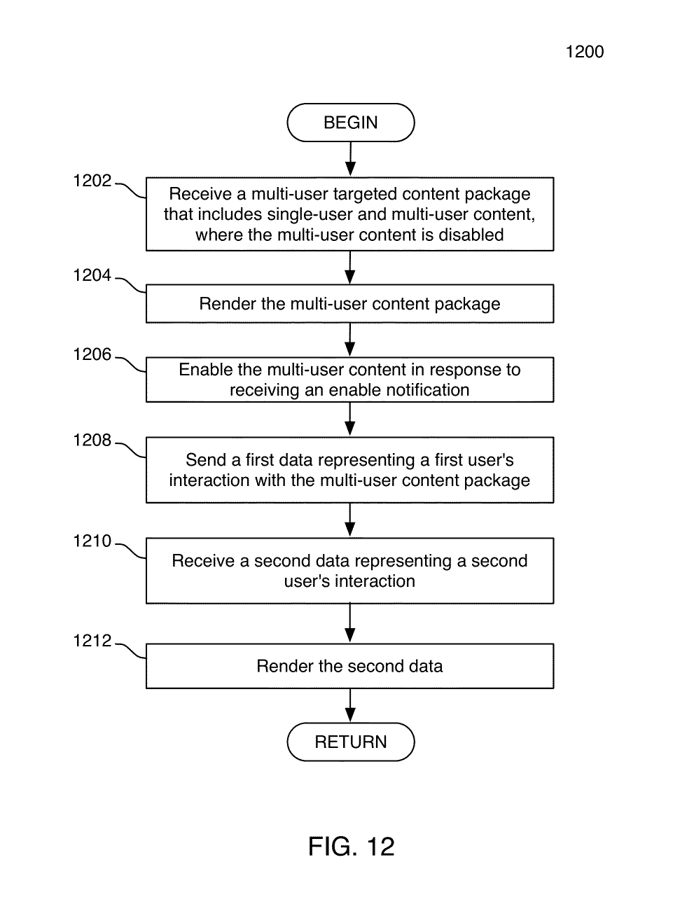

FIG. 12 is a flowchart illustrating steps in an exemplary method 1200 for rendering a multi-user content package. For the sake of clarity, this method is discussed in terms of an exemplary system such as is shown in FIG. 1. Although specific steps are shown in FIG. 12, in other embodiments a method can have more or less steps than shown.

A client device, such as user terminal 102, can receive a multi-user targeted content package that includes single-user and multi-user content (1202). In some cases, the multi-user content package can be configured such that the multi-user content is initially disabled. After receiving the multi-user targeted content package, the client device can render the multi-user content package (1204), which can include displaying the multi-user content package on a user interface. In some embodiments, a multi-user content package can have an associated number of currently engaged users and the client device can be configured to display the number in connection with the multi-user content.

At some later time, the client device can enable the multi-user content in response to receiving an enable notification (1206). In some cases, the enable notification can be received once a predefined number of users have received the multi-user content package. Furthermore, in some cases, the client device can receive the enable notification prior to the user interacting with the multi-user content package. However, in some cases, the client device can receive the enable notification in response to the user's interaction with the multi-user content package, such as by the user clicking on a banner advertisement that activates multi-user content. Once the user interacts with the multi-user content package, the client device can send a first data representing the user's interaction with the multi-user content package (1208). The client device can send the first data to the content delivery system 106 and/or the multi-user content system 108.

Additionally, at some point, the client device can receive a second data representing a second user's interaction with the multi-user content package on a second client device (1210). Upon receiving the second data, the client device can render the data so that the user can see the second user's interaction with the multi-user content package (1212). For example, the second data can represent a move in a multi-player game and then the move can be displayed to the first user on the client device. After the client device renders the second data, the client device can resume previous processing, which can include repeating method 1200.

In some embodiments, the multi-user content package can include locked content. For example, the multi-user content package can include a bonus level or other enhancements that are initially locked. In response to the occurrence of a predefined event, the client device can receive a notification to unlock the locked content. For example, a predefined event can be the user completing a level, defeating another player, and/or interacting with the content for a predetermined period of time. In response to the occurrence of such an event, the client device can receive a notification to unlock bonus content.

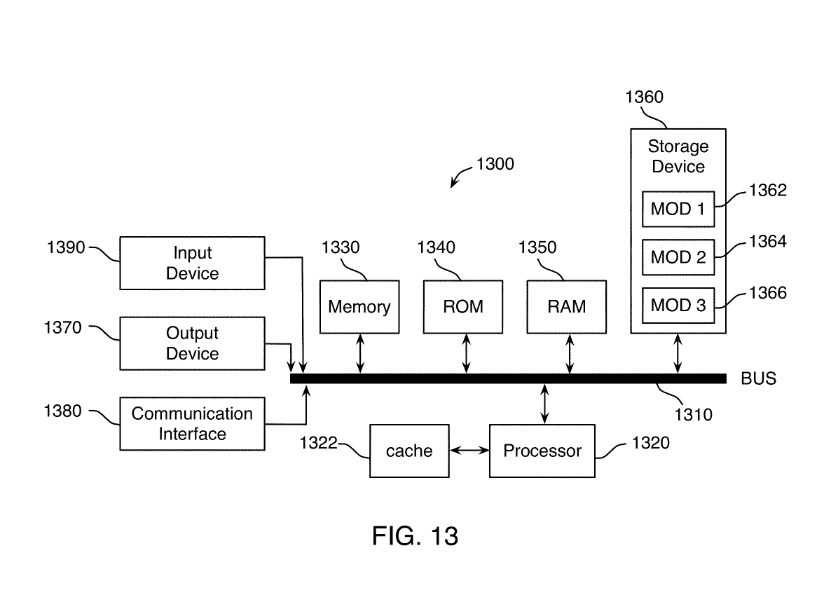

With reference to FIG. 13, an exemplary system 1300 includes a general-purpose computing device 1300, including a processing unit (CPU or processor) 1320 and a system bus 1310 that couples various system components including the system memory 1330 such as read only memory (ROM) 1340 and random access memory (RAM) 1350 to the processor 1320. The system 1300 can include a cache 1322 connected directly with, in close proximity to, or integrated as part of the processor 1320. The system 1300 copies data from the memory 1330 and/or the storage device 1360 to the cache for quick access by the processor 1320. In this way, the cache provides a performance boost that avoids processor 1320 delays while waiting for data. These and other modules can control or be configured to control the processor 1320 to perform various actions. Other system memory 1330 may be available for use as well. The memory 1330 can include multiple different types of memory with different performance characteristics. It can be appreciated that the disclosure may operate on a computing device 1300 with more than one processor 1320 or on a group or cluster of computing devices networked together to provide greater processing capability. The processor 1320 can include any general purpose processor and a hardware module or software module, such as module 1 1362, module 2 1364, and module 3 1366 stored in storage device 1360, configured to control the processor 1320 as well as a special-purpose processor where software instructions are incorporated into the actual processor design. The processor 1320 may essentially be a completely self-contained computing system, containing multiple cores or processors, a bus, memory controller, cache, etc. A multi-core processor may be symmetric or asymmetric.

The system bus 1310 may be any of several types of bus structures including a memory bus or memory controller, a peripheral bus, and a local bus using any of a variety of bus architectures. A basic input/output (BIOS) stored in ROM 1340 or the like, may provide the basic routine that helps to transfer information between elements within the computing device 1300, such as during start-up. The computing device 1300 further includes storage devices 1360 such as a hard disk drive, a magnetic disk drive, an optical disk drive, tape drive or the like. The storage device 1360 can include software modules 1362, 1364, 1366 for controlling the processor 1320. Other hardware or software modules are contemplated. The storage device 1360 is connected to the system bus 1310 by a drive interface. The drives and the associated computer readable storage media provide nonvolatile storage of computer readable instructions, data structures, program modules and other data for the computing device 1300. In one aspect, a hardware module that performs a particular function includes the software component stored in a non-transitory computer-readable medium in connection with the necessary hardware components, such as the processor 1320, bus 1310, output device 1370, and so forth, to carry out the function. The basic components are known to those of skill in the art and appropriate variations are contemplated depending on the type of device, such as whether the device 1300 is a small, handheld computing device, a desktop computer, or a computer server.

Although the exemplary embodiment described herein employs the hard disk 1360, it should be appreciated by those skilled in the art that other types of computer readable media which can store data that are accessible by a computer, such as magnetic cassettes, flash memory cards, digital versatile disks, cartridges, random access memories (RAMs) 1350, read only memory (ROM) 1340, a cable or wireless signal containing a bit stream and the like, may also be used in the exemplary operating environment. Non-transitory computer-readable storage media expressly exclude media such as energy, carrier signals, electromagnetic waves, and signals per se.

To enable user interaction with the computing device 1300, an input device 1390 represents any number of input mechanisms, such as a microphone for speech, a touch-sensitive screen for gesture or graphical input, keyboard, mouse, motion input, speech and so forth. An output device 1370 can also be one or more of a number of output mechanisms known to those of skill in the art. In some instances, multimodal systems enable a user to provide multiple types of input to communicate with the computing device 1300. The communications interface 1380 generally governs and manages the user input and system output. There is no restriction on operating on any particular hardware arrangement and therefore the basic features here may easily be substituted for improved hardware or firmware arrangements as they are developed.

For clarity of explanation, the illustrative system embodiment is presented as including individual functional blocks including functional blocks labeled as a “processor” or processor 1320. The functions these blocks represent may be provided through the use of either shared or dedicated hardware, including, but not limited to, hardware capable of executing software and hardware, such as a processor 1320, that is purpose-built to operate as an equivalent to software executing on a general purpose processor. For example, the functions of one or more processors presented in FIG. 13 may be provided by a single shared processor or multiple processors. (Use of the term “processor” should not be construed to refer exclusively to hardware capable of executing software). Illustrative embodiments may include microprocessor and/or digital signal processor (DSP) hardware, read-only memory (ROM) 1340 for storing software performing the operations discussed below, and random access memory (RAM) 1350 for storing results. Very large scale integration (VLSI) hardware embodiments, as well as custom VLSI circuitry in combination with a general purpose DSP circuit, may also be provided.

The logical operations of the various embodiments are implemented as: (1) a sequence of computer implemented steps, operations, or procedures running on a programmable circuit within a general use computer, (2) a sequence of computer implemented steps, operations, or procedures running on a specific-use programmable circuit; and/or (3) interconnected machine modules or program engines within the programmable circuits. The system 1300 shown in FIG. 13 can practice all or part of the recited methods, can be a part of the recited systems, and/or can operate according to instructions in the recited non-transitory computer-readable storage media. Such logical operations can be implemented as modules configured to control the processor 1320 to perform particular functions according to the programming of the module. For example, FIG. 13 illustrates three modules Mod1 1362, Mod2 1364 and Mod3 1366 which are modules configured to control the processor 1320. These modules may be stored on the storage device 1360 and loaded into RAM 1350 or memory 1330 at runtime or may be stored as would be known in the art in other computer-readable memory locations.

Embodiments within the scope of the present disclosure may also include tangible and/or non-transitory computer-readable storage media for carrying or having computer-executable instructions or data structures stored thereon. Such non-transitory computer-readable storage media can be any available media that can be accessed by a general purpose or special purpose computer, including the functional design of any special purpose processor as discussed above. By way of example, and not limitation, such non-transitory computer-readable media can include RAM, ROM, EEPROM, CD-ROM or other optical disk storage, magnetic disk storage or other magnetic storage devices, or any other medium which can be used to carry or store desired program code means in the form of computer-executable instructions, data structures, or processor chip design. When information is transferred or provided over a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable media.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, components, data structures, objects, and the functions inherent in the design of special-purpose processors, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Those of skill in the art will appreciate that other embodiments of the disclosure may be practiced in network computing environments with many types of computer system configurations, including personal computers, hand-held devices, multi-processor systems, microprocessor-based or programmable consumer electronics, network PCs, minicomputers, mainframe computers, and the like. Embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

The various embodiments described above are provided by way of illustration only and should not be construed to limit the scope of the disclosure. Those skilled in the art will readily recognize various modifications and changes that may be made to the principles described herein without following the example embodiments and applications illustrated and described herein, and without departing from the spirit and scope of the disclosure.

We claim:

1. A computer-implemented method comprising:
rendering, on a first client device, a multi-user targeted content package configured to provide a user interface, the multi-user targeted content package comprising single user content and multi-user content, wherein the single user content is enabled;
enabling, via a processor, the multi-user content in response to receiving an enable notification;
sending a first data representing a first user's interaction with the multi-user targeted content package, wherein the first data is sent to each of a plurality of client devices;
receiving a second data representing a second user's interaction with the multi-user targeted content package rendered on a second client device; and
rendering the second data.

2. The method of claim 1, wherein the enable notification is received in response to a plurality of client devices having received the multi-user targeted content package, wherein the plurality of client devices comprises a predefined minimum number of client devices.

3. The method of claim 1, wherein the multi-user content has an associated number of currently engaged users and wherein the rendering further comprises displaying in connection with the multi-user content the associated number of currently engaged users.

4. The method of claim 1, wherein the enable notification is received in response to the first user's activation of the multi-user content.

5. The method of claim 1 further comprising:
wherein the multi-user targeted content package further comprises locked content; and
receiving a notification to unlock the locked content, wherein the unlock notification is received in response to the occurrence of a predefined event.

6. The method of claim 5, wherein the occurrence of the predefined event is at least one of completion of a multi-user targeted content package session, engagement with a predefined number of multi-user targeted content packages, or a predefined achievement in the multi-user content.

7. A computer-implemented method comprising:
receiving a plurality of requests for a targeted content package from a plurality of client devices, the plurality of client devices associated with a plurality of users;
selecting, via a processor, a group of client devices from the plurality of client devices requesting a targeted content package;
sending a multi-user targeted content package configured to provide a common user interface to each client device in the group of client devices, wherein the multi-user targeted content package is chosen based on the selected group of client devices, and further wherein the sending is delayed until the selected group of client devices reaches a predefined minimum number of client devices.

8. The method of claim 7, wherein selecting a group of client devices further comprises:
selecting the group of client devices based on a common assignment to an identified segment.

9. The method of claim 7, wherein selecting a group of client devices further comprises:
receiving at least one attribute associated with each client device;
selecting a client device to be included in the group of client devices based on the associated at least one attribute.

10. A system comprising:
a server configured to serve a multi-user targeted content package;
a first module configured to control the server to receive a request from a client device associated with a user for the multi-user targeted content package, the multi-user targeted content package comprising single-user content and multi-user content;
a second module configured to control the server to identify a plurality of multi-user targeted content packages for the requesting user, wherein each multi-user targeted content package has an associated number of engaged users, the number of engaged users indicating a number of users currently interacting with the multi-user content in the multi-user targeted content package;
a third module configured to control the server to prioritize the plurality of multi-user targeted content packages, wherein the prioritizing is based at least in part on the associated number of engaged users; and
a fourth module configured to control the server to serve to the requesting user, a multi-user targeted content package configured to provide a user interface, the multi-user targeted content package selected from the prioritized plurality of multi-user targeted content packages.

11. The system of claim 10 further comprising:
a fifth module configured to control the server to receive a notification from a client device associated with a user of a change in engagement with a multi-user targeted content package; and
a sixth module configured to control the server to update an associated number of engaged users for the multi-user targeted content package.

12. The system of claim 11, wherein the change in engagement is an activation of the multi-user content.

13. The system of claim 11, wherein the change in engagement is an exit from the multi-user content.

14. The system of claim 10, wherein the prioritizing further comprises ranking a multi-user content package lower when the associated number of currently engaged users is above a predefined threshold value.

15. The system of claim 10, wherein the prioritizing further comprises ranking a multi-user content package higher when the associated number of currently engaged users is within a predefined range.

16. A non-transitory computer-readable storage media storing instructions which, when executed by a computing device, causes the computing device to perform steps comprising:
receiving a request for a targeted content package from a client device associated with a user;
assigning the user to a set of users associated with a multi-user content package;
prioritizing the set of users;
selecting a subset of users from the prioritized set of users; and
delivering an instance of the multi-user targeted content package to each client device associated with each user in the selected subset of users, wherein the delivering is delayed until a predetermined number of users have been selected.

17. The non-transitory computer-readable storage media of claim 16, wherein the set of users are prioritized based on at least one of location, length of time since request, network bandwidth, user characteristics, or skill level.

18. The non-transitory computer-readable storage media of claim 16, wherein the user is assigned to the set of users associated with a multi-user targeted content package based on at least one of user profile, network bandwidth, or location.

19. The non-transitory computer-readable storage media of claim 16 further comprising:
receiving data representing a first user's interaction with the multi-user targeted content package; and
distributing the data to each client device associated with each user in the selected subset of users.

20. The non-transitory computer-readable storage media of claim 16 further comprising:
receiving data representing a first user's interaction with the multi-user targeted content package, the data corresponding to an achievement of a predefined event; and
recording the achieved predefined event in a user profile associated with the first user.

21. The non-transitory computer-readable storage media of claim 20 further comprising:
delivering a content package to a client device associated with the first user in response to the achievement of the predefined event.

22. The non-transitory computer-readable storage media of claim 21, wherein the content package unlocks content in the multi-user targeted content package.

23. The non-transitory computer-readable storage media of claim 21, wherein the content package enhances the multi-user targeted content package.

24. The non-transitory computer-readable storage media of claim 16, wherein prioritizing the set of users further comprises:
ranking a user based on the user's interaction history with multi-user targeted content packages.

25. The non-transitory computer-readable storage media of claim 24, wherein a user is ranked lower when the user's interaction history includes a predefined number of early exits from a multi-user targeted content package.

26. The non-transitory computer-readable storage media of claim 24, wherein a user is ranked higher when the user's interaction history includes a predefined number of completions of a multi-user targeted content package.

27. A computer implemented method comprising:
receiving a plurality of requests for a targeted content package from a plurality of client devices;
selecting, via a processor, a group of client devices from the plurality of client devices requesting a targeted content package;
sending a multi-user targeted content package configured to provide a user interface to each client device in the group of client devices, wherein the multi-user targeted content package comprises single user content and multi-user content, and further wherein the sending causes the multi-user targeted content package to be displayed with the single user content enabled; and
distributing a notification to each client device in the group of client devices to enable the multi-user content in the multi-user targeted content package.

28. The method of claim 27 further comprising:
receiving data representing a first user's interaction with the multi-user targeted content package; and
distributing the data to each client device in the group of client devices.

29. The method of claim 27, wherein the notification is distributed in response to detecting that at least a predetermined minimum number of users are engaged with the multi-user targeted content.

30. The method of claim 27, wherein the multi-user targeted content package comprises a multi-player game.

31. The method of claim 27, wherein the multi-user targeted content package includes a chat feature.

32. A product comprising:
a non-transitory computer-readable storage medium configured to store computer executable instructions; and
the computer executable instructions being configured to cause a computer to execute a method, the method comprising:
providing an initial graphical user interface configured to receive an input, the graphical user interface including invitational content;
upon receiving an input in the initial graphical user interface, providing a secondary graphical user interface including invitational content, and a multi-device portion, the multi-device portion configured to present a collection of data originating from at least two consumer devices.

33. The product of claim 32, wherein the computer-executable instructions further include:
multi-casting inputs received within the multi-device portion to the at least two consumer devices.

34. The product of claim 32, wherein the computer-executable instructions are configured to be executed by a consumer device.

35. The product of claim 32, wherein the computer-executable instructions are configured to be executed by an advertising system.
